(19) United States
(12) Patent Application Publication
(10) Pub. No.: US 2007/0277869 A1
(43) Pub. Date: Dec. 6, 2007

(54) Systems and methods for enhanced solar module conversion efficiency

(75) Inventors: Wei Shan, Fremont, CA (US); Gang Wang, Milpitas, CA (US); Xiao Dong Xiang, Danville, CA (US)

Correspondence Address: QUINE INTELLECTUAL PROPERTY LAW GROUP, P.C., P O BOX 458, ALAMEDA, CA, 94501, US

(73) Assignee: Intematix Corporation, Fremont, CA (US)

(21) Appl. No.: 11/788,042

(22) Filed: Apr. 17, 2007

Related U.S. Application Data
(60) Provisional application No. 60/795,699, filed on Apr. 27, 2006.
(60) Provisional application No. 60/799,599, filed on May 10, 2006.
(60) Provisional application No. 60/834,909, filed on Aug. 1, 2006.
(60) Provisional application No. 60/838,481, filed on Aug. 16, 2006.

(51) Int. Cl. H02N 6/00

(52) U.S. Cl. 136/246; 136/244

(57) ABSTRACT

The present inventions are solar cell assemblies comprising a combination of efficiency enhancing features, such as, a photovoltaic cell array including two or more members having different band gaps, dispersive optics capable of directing wavelengths of incoming light to the most efficient cells for those wavelengths, light concentrators to focus incoming light onto the appropriate cells, and electrically conductive light concentrators that can act as contacts and transmission paths for current generated in the assembly.

### CROSS-REFERENCE TO RELATED APPLICATIONS

This application claims priority to and benefit of prior U.S. Provisional Application No. 60/795,699, Photovoltaic Device with Laterally Varying Bandgap, filed Apr. 27, 2006; 60/799,599, Methods for Improvement of Solar-Energy Conversion Efficiency (Transmission Grating), filed May 10, 2006; 60/834,909, Systems and Methods for Enhanced Power Extraction from Concentrated Solar Modules, filed Aug. 1, 2006; and, 60/838,481, Enhanced Solar Energy Conversion Using a Holographic Volume Grating, filed Aug. 16, 2006. The full disclosure of the prior applications are incorporated herein by reference.

### FIELD OF THE INVENTION

Embodiments of the present invention are directed to the field of photovoltaics (PV) technology to convert solar energy directly into electrical energy. The field of the invention is specifically directed to optical concentrator systems that convert solar energy into electricity. A plurality of PV cells with different band gaps may be incorporated into the concentrator to better match the spectral distribution of incident sunlight photon flux. Large reflector hardware can provide electrical contact and transmission functions. Dispersive optics can separate and direct incoming light to PV cells with appropriate band gaps to enhance the conversion efficiency of the systems.

### BACKGROUND OF THE INVENTION

Current solar energy conversion efficiency of PV cells based on single semiconductor material has an intrinsic limit of approximately 31%. The fundamental energy losses in a single-junction solar cell made of a semiconductor material, such as silicon, largely result from the mismatch between the incident solar spectrum and the spectral absorption result from the mismatch between the incident solar spectrum and the spectral absorption properties of the material (see, e.g., M. A. Green, Solar Cells: Operating Principles, Technology and Systems Application (Prentice Hall, Englewood Cliffs, N.J., 1982)). Due to the discrete band structure of semiconductors, there are essentially two kinds of spectral losses for a solar cell using a given material:
1. Sub-bandgap Loss: Only photons with energy equal to or greater than the fundamental band gap will be absorbed and can contribute to the electrical output of a photovoltaic (PV) device. Photons with energy Eₚₕ lower than the band gap E_{g} of the material are transmitted through the solar cell because that parts of the solar spectrum are not absorbed and do not contribute to the electrical output. Such sub-bandgap losses are one of the main loss mechanisms limiting the efficiency of conventional single-junction solar cells. For example, 20% of solar irradiance will not used by a Si-based solar cell because of incident photon energies smaller than the band gap of Si (1.1 eV);
2. Thermalization Loss: Photons with energy Eₚₕ larger than the band gap are absorbed, but the excess energy Eₚₕ-E_{g} is not used effectively due to thermalization of the electrons that process emits phonons (heat) rather than photons, thus not available for conversion to electricity. FIG. 1 shows a comparison between the converted energy and thermalized energy (wasted excess energy) for a Si solar cell based on Shockley-Queisser model (see, e.g., W. Shockley and H. J. Quiesser, J. Appl Phys. 32, 510(1961)) using Air Mass 1.5 Global (AM1.5G) spectral irradiance as reference. This type of loss can be of the largest portion in the energy that is wasted depending on the material composition of a device as well as the structural configuration of the device. This loss mechanism accounts for as much as 50% loss of solar energy in a single-junction Si PV cell.

To overcome these problems of semiconductor solar cells, and thereby increase the power output of single-junction solar cells, a number of schemes of better use of the solar spectrum have been proposed in the past decades. Photon energy down and up conversions have been among the often discussed in terms of modifying solar spectral irradiance. Down conversion typically converts one high-energy photon into two lower energy photons more compatible with the photovoltaic cell, thus reducing excess-energy losses of incident short wavelength photons. Up conversion can convert two low-energy photons into one higher-energy photon suitable for conversion in a PV cell. However, these conversions require second-order quantum processes involving three photons. Therefore, these processes are often unsuitable for conversion of normal solar irradiation inputs.

An approach that can provide higher solar-energy conversion efficiency is to employ two or more PV cells with different energy band gaps with each cell converting part of the solar spectrum at maximum efficiency. In this practice, PV cells with different energy gaps have been stacked in series with a cell of wide band gap on the top and cells with narrow band gaps positioned underneath sequentially. The top cell converts the short-wavelength (higher photon energy) part of solar spectrum and allows the other part of the spectrum transmitted down to the cells of smaller band gaps below in the stack, and so on, reducing the waste of excess energy. Monolithic double-junction GaInP/GaAs and triple-junction GaInP/GaAs/Ge have been developed over the last twenty years, and have obtained the highest efficiency of any solar cells. These multilayer III-V semiconductors based cells take advantage of the relatively good lattice match of constituent materials but are very expensive to fabricate. These monolithic multi-junction cells have been well adapted for space applications as long-duration power supply in satellites and space vehicles. The high costs of materials and device fabrication have limited their terrestrial applications in flat plate forms.

Ideally, the optimal performance of a monolithic multi-junction solar-cell structure is achieved when an equal number of photons is absorbed and converted in each cell that is connected with other cells in series. However, this requirement can only be met, if at all, at a given spectral distribution such as AM1.5. Otherwise the overall output current is severely limited by the spectral mismatch under various terrestrial conditions. An obvious solution is to mechanically stack the cells on top of each other physically instead of monolithically with separate contacts in parallel. But the complexities of fabrication and assembly of this type tandem multi-junction cell structure make it even more inhibitively expensive.

Concentration of sunlight by optical means can offer advantages in reducing high solar cell usage by replacing much of the cell area for a concentrator area using low-cost optical elements and mounting components while enhance solar-energy conversion efficiency by extracting more power out of solar cells. Increased conversion efficiency can achieved by concentration of solar radiation because the open-circuit voltage of a p-n junction solar cell is proportional to the logarithm of light generated current density, which increases linearly with the incident light intensity. It makes perfect sense to combine tandem multi-junction solar cells with concentrators to achieve high conversion efficiency while keep system cost down since the cost of solar cells is only a small part of it.

Another approach to extracting voltages from broad input light spectrum is to pass certain frequencies to a suitable PV cell while reflecting unsuitable frequencies to more optimum cells. For example, prior art described in U.S. Pat. No. 4,328,389, granted to Stern et al, utilizes broad-band reflectors, and in U.S. Pat. No. 5,902,417, granted to Lillington et al, uses band-pass filters to have spatially located solar cells of different energy band gaps spectral-selectively irradiated as attempt to achieve higher conversion efficiency. In these approaches, however, the mechanical and optical complexities make it undesirable in a concentration system because the more optical components are involved the lower throughput efficiency of the optics in the system.

As solar concentration is increased, a significant decrease in conversion efficiency can result as ohmic resistances of the external and internal circuits increase, e.g., due to increased loading of the solar cells. The primary sources of the increased electrical resistances can include, e.g.:
1. Electrodes: The resistance of electrodes that are in direct contact with the surfaces of solar cells can affect conversion efficiency drastically when the cells are working under concentrated sunlight. For instance, a 120-mm long and 0.7-mm wide thin electrode on a long linear solar cell stripe has a resistance of 0.1Ω. It may introduce a 25-mV drop in voltage, under merely six times (×6) concentrated solar irradiance, when the output electrical leads are connected to one end of the electrode of the solar cell. That is equivalent to a 4% decrease in the output voltage of Si p-n junction cells taking into account the open-circuit voltage approximately around 0.6 V for the cells;
2. Electrical connections: Connections, such as the wirings between electrodes and buses, can be sources of high resistance due to (i) contact potential difference (CPD), which develops between solids of different work function, and (ii) local corrosion resulting in the formation high-resistance scales. Therefore, it is desirable to minimize or, preferably, eliminate interwire connections. Also, the engineering of connections, e.g., those between the leads and the other circuit elements, can strongly influence the resistance;
3. Electrical leads (wires): Electrical leads usually are made of metal wires with resistances substantially lower than those of the electrodes on solar cells. In this sense, selection of the wire seems to be of secondary importance. However, inappropriately thin leads and wires may inadvertently cause energy loss; and,
4. Measuring and control equipment: The internal resistances of the measuring and control equipment can influence the amount of power scavenged by these systems. For example system voltmeters should have resistances as high as possible, and ammeters should have resistances as low as possible, to minimize monitoring losses.

In order to achieve the maximum conversion efficiency, the electrical resistances of all of these items must be minimized. Current systems fail to reduce these resistances in a cost-effective manner.

Concentration of sunlight by optical means is known to be an advantageous approach to reduce high solar cell usage by replacing much of the cell area for a concentrator area using low-cost optical elements and mounting components while enhance solar-energy conversion efficiency by extracting more power out of solar cells. Increased conversion efficiency is achieved by concentration of solar radiation because the open-circuit voltage of a p-n junction solar cell is proportional to the logarithm of light generated current density, which increases linearly with the incident light intensity.

It would be ideal to design a concentrator capable of collecting as much solar irradiance as possible in a cell as small as possible. However, the maximum achievable optical concentration, which is defined as the ratio between the irradiance incident on the concentrator module aperture and that incident on the cell, is limited by the acceptance angle α of a given axisymmetric concentrator [R. Winston, J. C. Miñano, and P. Benítez, Nonimaging Optics, Elsevier, Amsterdam, 2005]:

$${C}^{max} = \frac{π}{{A}_{P}} = \frac{1}{{sin}^{2} α} . \qquad ( 1 )$$

Therefore, it is typically important to have a small acceptance angle for a concentrator system in order to obtain high concentration. This trade-off between concentration ratio and acceptance angle can be balanced by using a tracking system to follow sun's movement so that the concentrator aperture faces the sun at any time all day long to collect the solar irradiance as much as possible. See, e.g., Solar Modules with Tracking and Concentrating Features, U.S. patent application Ser. No. 11/698,748.

The requirements of sun tracking can greatly increase the complexity of solar concentrators and significantly limit their applications. To overcome the problem, several schemes of reducing or eliminating the tracking requirements have been proposed, including the use of diffractive optics based on holographic volume gratings.

A diffraction grating is a collection of transmitting or reflecting elements that are separated by a distance comparable to the wavelengths of interest (grating constant). The elements can be a periodic thickness variation (surface relief) of a transparent material or a periodic refractive-index variation (volume) within a flat film formed along one dimension. A grating whose thickness significantly exceeds the fundamental fringe period recorded in it is said to operate in the Bragg diffraction regime and is called volume Bragg grating (VBG), where the extended volume of a medium serves to suppress (or “filter out”) all but the first diffraction order in reconstruction. A VBG can be made by a method of holography using two unit amplitude plane waves of common wavelength incident on a photosensitive medium making angles with the surface normal. The arrangement of incident light on the same side of the photosensitive medium records a transmission hologram, whereas incidence from opposite sides of the medium forms a reflection hologram.

VBGs are considered very useful spectral and/or angular selectors with highly adjustable parameters. Angles of incidence and diffraction, central wavelength, and spectral/angular width can be properly chosen by varying the grating thickness, period of refractive index modulation, and grating vector orientation. The physics of volume diffraction thus endows VBGs with a selectivity property that can be exploited to multiplex a number of holograms that are stored within the same physical volume and then diffract lights incident from different angles independently, thus greatly enhancing the overall capabilities of the volume grating to accept lights incident from a wide range of angles and diffract them to the same location.

Prior art described in U.S. Pat. Nos. 58/877,874 and 6,274,860 granted to Rosenberg utilize holographic planar concentrators with angular and spectral multiplexed reflection volume gratings to collect and concentrate the solar radiation without tracking. However, the disadvantage of high transmission losses and low concentration ratio makes the invention almost impossible for practical deployment.

While the prior art provides piecemeal improvements for particular situations, it does not provide satisfactory solutions. In view of the above, a need exists for more efficient concentrators and optical sorting systems to maximize conversion of photons from various regions of the input spectrum. Once light is captured, there remains a need to increase the efficiency of conversion and transfer to the grid. The present invention provides these and other features that will be apparent upon review of the following.

### SUMMARY OF THE INVENTION

In this invention, methods are provided to improve solar energy conversion efficiency of solar cells. For example, solar receiver conversion efficiency can be increased by incorporating a spectral dispersive mechanism such as transmission grating or prism into a solar concentrator to disperse incident sunlight so that the spectral distribution matches the band gap energies of a plurality of PV cells. Light concentrators can be included to reduce the required PV cell area and reduce or eliminate solar tracking requirements. The photovoltaic cells can be presented in a lateral array geometry to receive appropriate light wavelengths from the dispersive devices and concentrators.

The devices of the invention can include various combinations of features that increase the efficiency of a solar cell assembly. Efficiency can be enhanced, e.g., by diffracting input light into multiple spectral groups and directing the groups onto two or more PV cells having appropriate band gap energies for efficient conversion of each group into electrical energy. The PV cells can be in a lateral array, e.g., in substantially the same plane or at substantially the same distance from dispersion optics, to simply receive the dispersed light wavelengths. In many embodiments, the solar cell assembly can include PV cells with 3 or more band gap energies to more closely match the energies of dispersed light spectrum groups. The solar cell assemblies can include reflective or refractive concentrator optics, e.g., between the dispersive optics and the PV cells, to reduce the area of cells necessary to convert incoming light. Volume Bragg transmission gratings can be employed to disperse and or concentrate incoming light onto PV cells of a receiver. The Bragg grating can be multiplexed to effectively receive incoming light from a broad range of input angles and/or to direct the light appropriately onto a PV cell array. The concentrator optics can be electrically conductive and in contact with electrodes of the PV cells to provide low resistance contacts and transmission of currents produced by the cells.

Methods of the invention can include dispersing incoming light into spectral groups, concentrating the dispersed light and directing the concentrated light spectra groups appropriately onto two or more photovoltaic cells having different band gap energies. The methods of the invention can employ the systems and devices of the invention to generate electric current.

In one embodiment of the systems, the solar cell assembly receivers include photovoltaic cells in an array with two or more cells having different band gap energies. For example, the invention can be a device for conversion of light energy into electrical energy. The device can include a lateral array of two or more different photovoltaic cells, with the different cells having different band gap energies. In preferred embodiments, the array cells include a first cell with a band gap energy of about 1 eV and a second cell with a band gap energy ranging from about 1.3 eV to about 2 eV. More preferred embodiments include three or more different photovoltaic cells; the first cell having a band gap energy of about 1 eV, the second cell having a band gap of about 1.3 eV, and the third cell having a band gap of about 2 eV. This arrangement can be very efficient at conversion of solar energy into electric current with reduced thermalization loss and/or sub-band gap loss. In preferred embodiments, the lateral array of different photovoltaic cells is arranged in the same plane, in the same hemispherical surface, in the same ellipsoid surface, the same parabolic surface or the same hyperbolic surface (e.g., surfaces of conic sections turned about their axes). In preferred embodiments, the cells with different band gaps are not stacked or arranged in different planes or arranged on a surface described by a axially turning conic section. In a more preferred embodiment, for purposes of compactness, the device does not include a three-dimensional array of photovoltaic cells. In typical embodiments, the solar cell assembly includes dispersive optics positioned in a light path between a light source and the lateral array of photovoltaic cells, so that light from the light source is dispersed spectrally by wavelength to appropriately illuminate the cells according to band gap energies.

In another embodiment, the devices for conversion of light energy into electrical energy include, e.g., dispersion optics in a light path between the exterior of the device and one or more photovoltaic cells, and also a light concentrator in the light path between the dispersion optics and the one or more cells. It is preferred that the photovoltaic cells of the device include two or more cells in a lateral array of cells, e.g., wherein adjacent cells in the array have different band gap energies. The dispersive optics can be positioned in the light path to appropriately disperse the light and illuminate the cells according to band gap.

In still other embodiments, the device for conversion of light energy into electrical energy includes one or more photovoltaic cells with a voltage potential between a first contact electrode and a second contact electrode when a surface of the cell is exposed to light. The device can further include a first metal reflector configured to reflect light onto the surface and in direct electrical contact with the first electrode or the second electrode of the PV Cell. The reflector can be fabricated from electrically conductive material to act as a conductor in a circuit when current is generated by the photovoltaic cell. In another aspect, the reflectors can be in heat conductive contact with the photovoltaic cell, thereby conducting heat from the photovoltaic cell. In some embodiments, the photovoltaic cell surface exposed to light is a front surface and the reflector contacts the first electrode on the back surface. In some embodiments, a metal electrical transmission buss is in direct electrical contact with the first electrode on the cell back surface and the conductive reflector is in direct electrical contact with the second electrode, e.g., at the back surface, a side surface or the front surface. In some embodiments, the device includes a second metal reflector configured to reflect light onto the cell photovoltaic surface. The second reflector can be, e.g., in direct electrical contact with the back surface first electrode and the first reflector can be in direct electrical contact with the second electrode. In preferred embodiments, the first electrode and/or second electrode are not in direct electrical contact with a wire, e.g., for the purpose of conducting current from the PV cells.

Additional embodiments of the invention employ volume Bragg gratings, e.g., to direct and/or disperse incoming light onto appropriate photovoltaic cells. For example, a device for conversion of light energy into electrical energy can include an a non-multiplexed or angularly multiplexed volume Bragg grating in a light path functioning to direct light onto one or more photovoltaic cells. The Bragg gratings can disperse incident light incoming form one or more directions onto a lateral array of cells comprising two or more different band gap energies. The grating can be positioned to disperse incident light into spectral components according to wavelength and to direct the spectral components onto cells of the array that have the closest band gap energy match at or above the energy of the spectral component. The multiplexed grating can include a primary grating with a primary incidence angle and one or more secondary gratings recorded in one or more Bragg nulls of the primary grating. The peripheral secondary incidence angles can be different from the primary angle, yet the light from different sources having common wavelengths can be directed to surfaces of the same PV cells. The grating can include from 2 to 8, or more, secondary incidence angles of secondary gratings recorded in the Bragg nulls. A light concentrator can be positioned in the light path and configured to concentrate light upon the one or more cells.

Where the reflector also acts as part of the solar cell assembly electrical circuit, the reflector can be, e.g., a conductive compound parabolic reflector, a compound hyperbolic reflector, a compound elliptic reflector, a total internal reflection concentrator, and/or the like. The reflectors can act as conductors and light concentrators, e.g., in a device including two or more of the photovoltaic cells, each with different band gap energies, and including dispersive optics positioned in a path of the light to disperse the light and functionally illuminate the cells according to band gap energy.

Dispersive optics in the devices and methods can be any suitable to a particular application. For example, the optics to separate incoming light according to energy can include low profile prism arrays, prism arrays without zone spacing, Zenger prisms, Zenger prism arrays, grisms (a combination of a prism and grating arranged to keep light at a chosen central wavelength undeviated as it passes through), holographic volume Bragg gratings, a multiplexed volume Bragg gratings, and/or the like. The dispersive optics can function by refraction or transmit substantially all visible light incident from a normal angle. In many preferred embodiments the dispersive optics do not function by reflection or do not function to separate light into groups by absorbing some light spectrum group (range of contiguous wavelengths).

Light concentrators of the invention can include a reflective and/or refractive light concentrator positioned in the light path between the light source and the PV cells of the receiver. In preferred embodiments, the light concentrators are positioned in the light path between the light source and the dispersive optics. Typical light concentrators can include, e.g., lenses, cylindrical lenses, compound parabolic reflectors, compound hyperbolic reflectors, compound elliptic reflectors, total internal reflection concentrators and/or the like.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular methods or solar conversion systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “a reflector” can include a combination of two or more reflectors; reference to “conductors” can include mixtures of conductors, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

As used herein, the term “lateral array of cells” refers to two or more cells arranged laterally in relation to each other, e.g., with adjacent edges. The lateral array can be a planar array of cells. The lateral array can be two or more cells arranged in a curved surface described by the rotation of a conic section about its axis. Cells stacked in layers one over the other are typically not considered members of the same lateral array.

Photovoltaic cells with different band gap energies typically have a band gap energy difference of at least 0.1 eV. “Different” photovoltaic cells have different band gap energies.

A “light path” as used herein, refers to the path a light beam takes from a light source to illuminate a photovoltaic cell in a device of the invention. The light path can be, e.g., from a light source, through dispersive optics, and reflecting from concentrator optics onto the converting surface of a photovoltaic cell.

The “exterior” of a device, as used herein, refers to a position outside the volume defined by the outer surfaces of the device hardware and the aperture of light input optics.

“Dispersive optics” of the invention are optics that disperse incident polychromatic light according to wavelength. For example, a prism can disperse white light into spectral groups of different colors.

Light is “appropriately” dispersed or directed to a member of a photovoltaic cell array if the light wavelength provides more electrical current from the cell member than it would if directed to another member of the array. Typically, this requires that the light is directed to a cell with the closest band gap energy less than or equal to the energy of the light wavelength.

Used herein, the “front surface” of a photovoltaic cell is the surface upon which light functionally strikes the cell to generate a voltage in the output electrodes.

The term “receiver” refers to a photovoltaic receiver including one or more photovoltaic cells.

### BRIEF DESCRIPTION OF THE DRAWINGS

FIG. 1 is a chart showing solar energy converted by a p-n Si PV cell and excess energy wasted. Calculations use a Shockley-Quisser model based on AM1.5G spectral irradiance.

FIG. 2 is a schematic diagram showing dispersion of sunlight spatially in wavelength by a dispersive optics such as a transmission phase grating or a prism. Dispersed wavelengths fall on to laterally deployed semiconductor PV receivers with different band-gap energies appropriate to wavelengths received.

FIG. 3 is a schematic diagram showing theoretical calculations of energy convertible from the solar irradiance (AM1.5G) using laterally deployed I-III-dichalchogenide based solar cells with three different band-gap energies of 1.4 eV, 0.9 eV and 0.7 eV.

FIG. 4 is a schematic illustration of solar concentrator functionality using dispersive optics (e.g., a prism or a diffractive transmission grating, or a combination of both) and a plurality of laterally deployed PV cells with different energy gaps.

FIG. 5A is a schematic diagram showing the concept of making a low-profile prism array based on functional aspects of a bulk prism.

FIG. 5B is a schematic diagram of the functionality of a Zenger prism in a prism array.

FIG. 5C is a schematic diagram showing a combination of a transmission grating and a right-angle prism (grism), as well as the functionality of a grism.

FIG. 6A is a schematic illustration of two geometrical arrangements for a solar concentrator using a CPC to concentrate the diffracted light from a low-profile prism array (LPPA). The LPPA is attached to a transparent front panel allowing normal incidence of the sunlight. A plurality of PV cells with different energy gaps are laterally deployed in the receiving area of CPC assembly.

FIG. 6B is a schematic illustration of a solar panel using CPC as a means of concentration. A Zenger-prism based low-profile prism array is attached to the transparent front panel allowing normal incidence of the sunlight. A plurality of PV cells with different energy gaps are laterally deployed in the receiving area of CPCs.

FIG. 6C is a schematic illustration of a CPC comprised from Zenger-prism based low-profile prism array and a plurality of PV cells with different energy gaps.

FIG. 7 is a schematic diagram of an angular multiplexed volume holographic grating in conjunction with surface-normal holographic lens array to provide large acceptance angle and better optical coupling for a concentrator with a planar multi-band solar receiver structure.

FIG. 8 is a schematic diagram of a diffractive device based on holographic volume Bragg grating. The grating is capable of providing spatial distribution of solar spectrum according to wavelength in the first diffraction order while the extended volume of a medium serves to suppress (or “filter out”) all the other diffraction orders in reconstruction.

FIG. 9 is a chart showing the angular selectivity of a non-multiplexed volume Bragg grating.

FIG. 10 is a schematic diagram of an volume Bragg grating angularly-multiplexed with several holograms to accept light incident from various angles, but diffracting their corresponding spectral components (groups) along substantially parallel paths.

FIG. 11 shows a chart of diffraction efficiency for an angular-multiplexing volume grating with five holograms struck with light from 5 incident angles.

FIG. 12A shows a schematic diagram of an angularly-multiplexed diffractive device providing a large acceptance angle for a solar concentrator that uses a convex lens to concentrate incident sunlight from various angles.

FIG. 12B is a schematic diagram of an angularly-multiplexed diffractive device providing a large acceptance angle for a solar concentrator that uses a CPC to concentrate incident sunlight onto a PV cell.

FIG. 13 is a schematic diagram a solar concentrator including a multiplexed grating dispersive device and a plurality of laterally deployed PV cells with different energy gaps.

FIG. 14 is a schematic diagram of a compound parabolic solar concentrator assembly. A pair of parabolic reflective mirrors are used to concentrate the sunlight onto a solar receiver attached to the end of the assembly.

FIG. 15 is a schematic diagram presenting a scheme for electrical connection between a solar cell with back contact electrodes and CPC reflectors which also act as electric current conductors.

FIG. 16A is a schematic diagram presenting another scheme for electrical connection between a solar cell with back contact electrodes and metal CPC reflectors to contact and conduct electricity through both electrodes of the solar cell.

FIG. 16B is a schematic diagram presenting a scheme for electrical connections between a solar cell with lateral contact electrodes and CPC reflectors.

FIG. 17 is a schematic diagram presenting a scheme for electrical connections between a solar cell with contact electrodes on top and bottom surfaces and associated rear bus and CPC reflector contacts.

FIG. 18 is a schematic diagram of another scheme for electrical connections between two CPC reflectors and a solar cell with contact electrodes on its top and bottom surfaces.

### DETAILED DESCRIPTION

The present inventions provide combinations of features useful in increasing the efficiency and lowering the cost of power production from sunlight.

Disclosed herein is a solar energy receiving system designed to employ the principle of matching the band-gap energies of PV cells with the solar spectral distribution for increasing the efficiency of converting solar energy into electricity. The overall efficiency of solar conversion assemblies can be enhanced, e.g., using lateral arrays of PV cells having various band gap energies, in combination with improved dispersive optics, improved current conductors and contacts, and light concentrators.

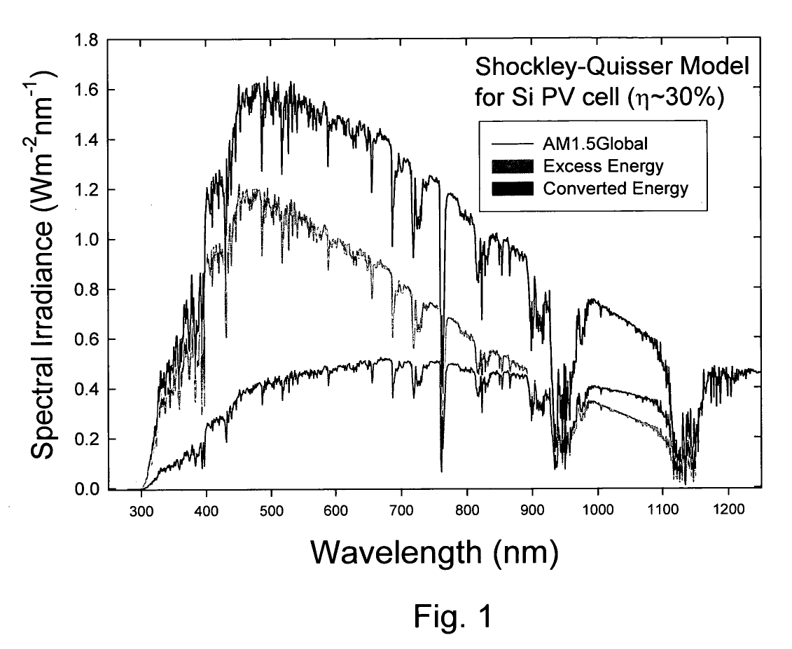

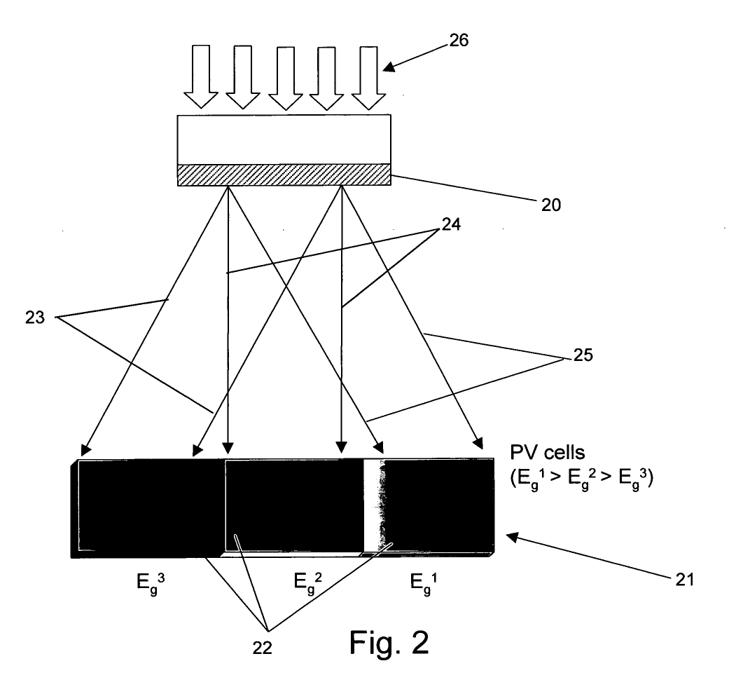

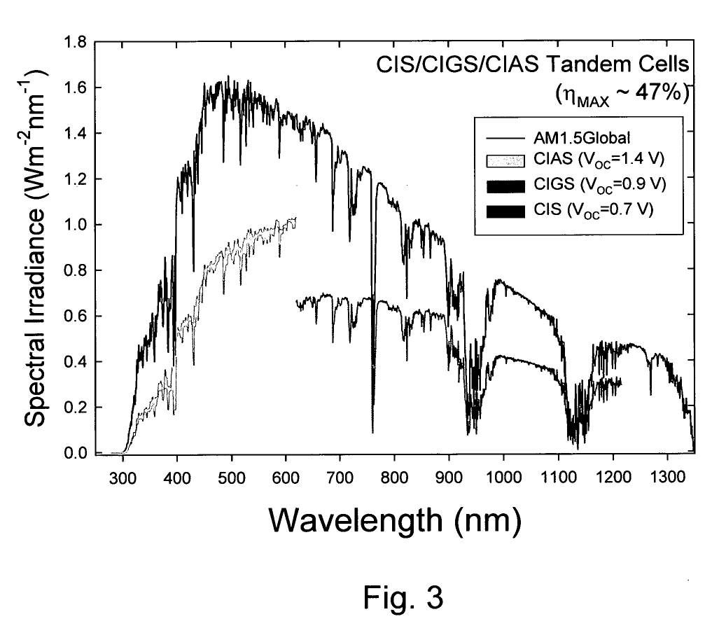

A simple and relatively straightforward way to match the band-gap energies of solar cells with the spectral distribution of solar irradiance is to utilize the dispersive optics 20 of a prism and/or a diffraction grating to spatially distribute photons of sunlight with different energies to the most compatible (appropriate) cells at different locations. By selecting a plurality of semiconductor PV cells with different band-gap energies, and placing them under the illumination of the dispersed sunlight in a planar configuration, as illustrated in FIG. 2, the efficiency of conversion can be increased substantially. For example, a planar multi-band PV receiver 21, analogous to the stacked multi-junction tandem solar cells of prior art, can be constructed by using three cells 22, laterally displaced cells with E_{g}¹, E_{g}², E_{g}³ and E_{g}¹>E_{g}²>E_{g}³. Photons in the violet-blue-green spectral region 23 are directed to irradiate on cell of E_{g}¹, photons in the yellow-red wavelength range 24 directed to illuminate cell of E_{g}², and photons in the infrared part 25 are directed to cell of E_{g}³. Such an arrangement can provide efficiency in conversion of incident sunlight 26 comparable to known stacked PV designs. FIG. 3 shows theoretically calculated results using such a multi-band PV receiving system having three different band gap energies laterally deployed, as discussed above. The AM1.5G solar irradiance is used in the calculation. The filled areas in the figure are the portions of solar energy that would be converted at AM1.5G solar irradiance. With the three solar cells having band gaps of 1.02, 1.3, and 2.0 eV, better use of the photon flux spectral distribution is evident. A theoretically calculated conversion efficiency would be ˜47%, as compared to the results of ˜31% for single-junction Si PV cells shown in FIG. 1. The increased efficiency would be mostly from a significant reduction of thermalization loss.

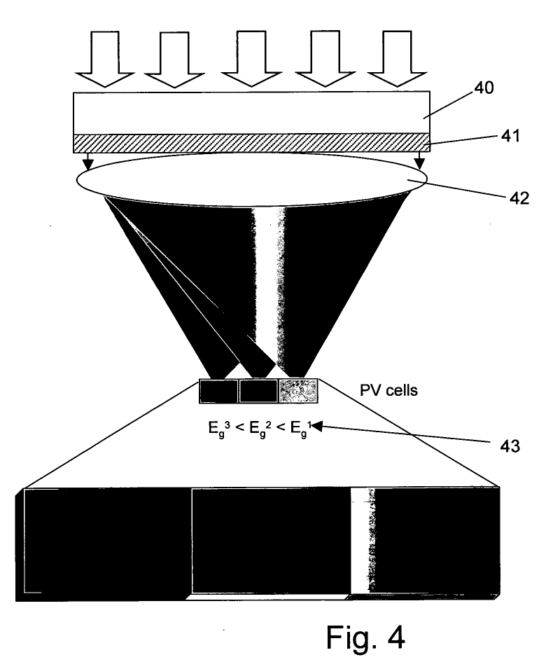

A drawback of the simple embodiment depicted in FIG. 2 is that it requires very high usage of solar cells, e.g., up to three times the area of the dispersive optics aperture. This problem can be eliminated by using a solar concentrator to increase the input aperture. Use of concentrator hardware can significantly reduce PV cells requirements while maintaining the advantage of using multi-band tandem cell structure. Schematically illustrated in FIG. 4 is an abstract representation of such solar concentrator. The concentrator includes a transparent substrate 40, dispersive optics 41 may or may not be attached to the substrate, concentrating optics 42, and a plurality of semiconductor PV cells 43. It can also include a fixture to maintain the optical components and the cells together in a desired configuration.

Dispersion to Appropriate PV Cells

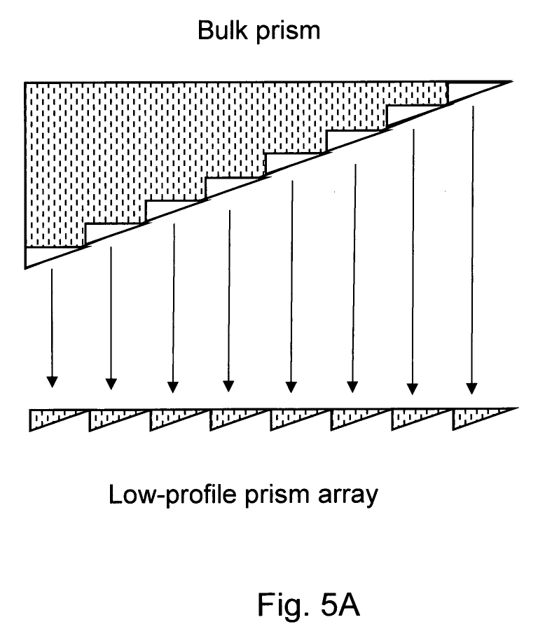

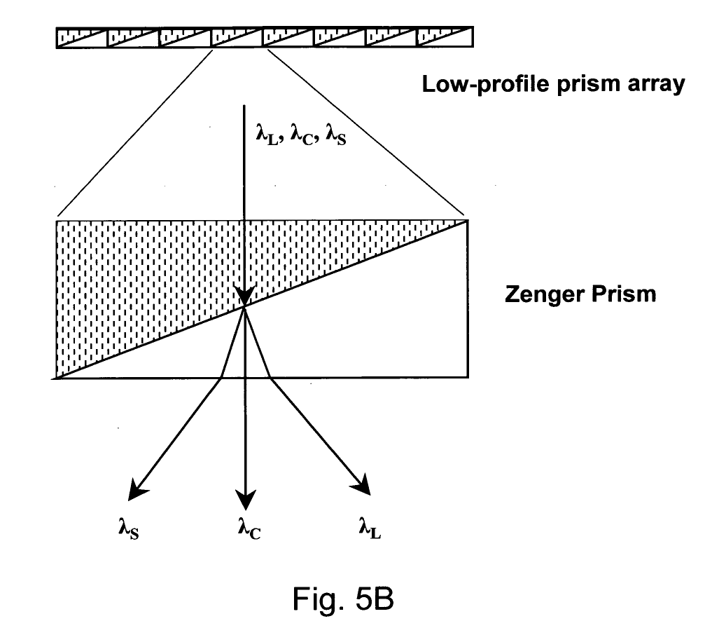

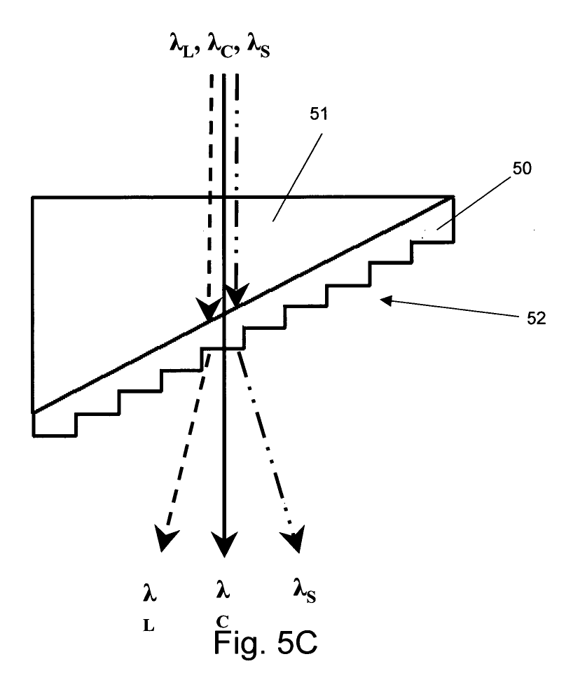

In one embodiment, the dispersive optics is a prism capable of providing spatial distribution of solar spectrum in wavelength. A dispersive prism is an optical device utilizing the index of refraction relationship to wavelength for separation of white light into its spectral components. The refractive nature of a prism material disperses parallel rays or collimated radiation at different angles from the prism according to wavelength. As a result, the white light is dispersed spatially by wavelength. For example, the spectral distribution of incident sunlight can be spatially resolved using a prism of right-angle trapezoid shape at a proper prism angle to provide adequate angular dispersion. However, simply mounting a single large bulk prism on a solar concentrator would typically prove undesirable practice for a number of obvious reasons. For example, such large prisms would have poor transmission related to the thickness, would be difficult to align due to their bulk, and be materially expensive. Instead, it is preferred to employ low-profile prism array (LPPA) specifically designed in this invention. The prism arrays are sheets comprising a plurality of right angle trapezoids with the same prism angle and aspect ratio as a bulk prism but much smaller in size. As shown in FIG. 5, the low-profile prism array can eliminate the massive bulk of old style prisms, so the overall profile of the prism minimized while retaining full dispersion power. A low-profile prism array can function as a bulk prism to decompose radiation in a way reminiscent to a Fresnel lens in focusing light rays. However, unlike a Fresnel lens on which the zone spacing changes from the center to edges, the dimensions of each individual prism in a low-profile prism array can be primarily the same. In preferred embodiments, undesirable effects of interference and diffraction from the periodicity of the prism array are avoided by keeping the width of each individual prism at least two orders of magnitude greater (e.g., ranging from 0.1 to 100 mm), than the wavelengths of incident light. However, it is not necessary for each individual prism in an array to be of the same size, but it is preferred that the prism dispersive properties be about the same in the LPPAs of the invention.

For constructing low-profile prism arrays, transparent materials such as, e.g., glass or plastics with low Abbe number are preferred. Prisms made from materials with lower Abbe numbers produce larger angular dispersion of solar spectrum at a given prism angle. Accordingly, a prism of low-Abbe number material can have a smaller prism angle to produce a required angular dispersion, as compared to a prism of high-Abbe number material. There are several advantages of using small prism angles. First, it produces smaller angular deviation between the incident sunlight and the emerging rays of dispersed light in different wavelengths, thus reducing optical alignment difficulties. Second, a small prism angle is more desirable in minimizing the loss at the surfaces of a prism because reflection losses increase with incident angle. Importantly, a smaller prism angle further results in a lower profile for a prism, reducing material volume and weight. For instance, as a preferable polystyrene prism has an Abbe number of 30.87 and refractive index of 1.59 at 588 nm. A right-angle polystyrene prism with a 20° prism angle can produce more than 2° of angular dispersion from 400 to 1200 nm; the a deviation angle would be 13° for the central ray of the fanned-out spectral band relative to the incident light. If a high-Abbe number material, such as BK7 glass (Abbe number=64.29, and refractive index=1.5168 at 588 nm) were used, it would require a 34° prism angle to achieve a 2° angular dispersion for the same wavelength range (400-1200 nm). The deviation angle would be 24°—almost twice as large as the value obtained from said polystyrene prism. A Zenger style prism can further provide benefits with regard to deviation angle. This particular type of prism is structured using two right-angle prisms having the same refractive index at the central ray of a spectral band of interest, but having different Abbe numbers. When the rays of the spectral band are normal incident and propagating through a Zenger prism, as shown in FIG. 5B, the central ray can be undeviated while other rays are deviated and dispersed.

A concentrator can include dispersive optics 41 consisting of, e.g., a low-profile prism array, a transparent substrate 40 to which the array is attached, a plurality of semiconductor PV cells 43 with different band-gap energies, and an optical component 42 that illuminates the cells with concentrated and spectrally resolved and redirected sunlight that has passed through the array, as shown in FIG. 4.

In another embodiment, a transmission grating can be used as the dispersive optics in a solar concentrator, e.g., as illustrated in FIG. 4, for reducing of PV cell area requirements while the diffractive property of the grating spectrally disperses the sunlight to appropriate PV cell array members. A diffraction grating is a collection of transmitting or reflecting elements that are separated by a distance comparable to the wavelengths of interest (grating constant). The elements can be, e.g., a periodic thickness variation (surface relief) of a transparent material or a periodic refractive-index variation (volume) within a flat film formed along one dimension. A beam of white light incident on a grating can be separated into its component colors upon diffraction by the grating, with each color diffracted in a different direction, providing spatial distribution in wavelength for the light.

The transmission grating used in the solar concentrator is typically designed to disperse incident sunlight spatially according to wavelength. The grating can be, e.g., a mechanically ruled or holographic fringe-patterned surface-relief grating, or an interference (holographic) volume grating. Volume holographic gratings have an advantage of a significant thickness suppressing all but the first diffraction order in light wave reconstruction over surface-relief gratings. The transparent substrate material should be glass of high transmittance to the sunlight in the operation wavelength range of the solar cells in the concentrator.

A combination of a grating 50 and prism 51, referred to as grism 52 in FIG. 5C, can preferably be used as the dispersive optics in concentrators of the invention. A grism is a dispersing device that has a transmission grating replicated on the hypotenuse face of a right-angle prism. In preferred embodiments, a normal incidence and in-line output for one wavelength, e.g., a mid-energy wavelength compared to total useful light input. The dispersion characteristic of the grism can be determined by the straight-through wavelength, the refractive index of prism, and the grating constant. In most cases, the blaze angle of a transmission grating deviates from its surface normal, making normal incidence of sunlight onto it for dispersion a poor choice. Deployment of a grism with its straight-through wavelength appropriately setting at the central ray of a selected spectral band from solar spectrum can allow the preferred normal incidence of sunlight onto the concentrator acceptance aperture.

Concentrators

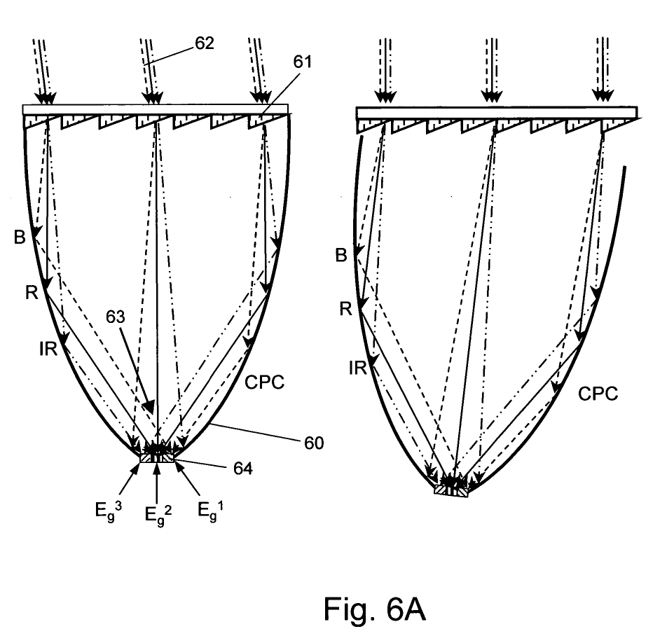

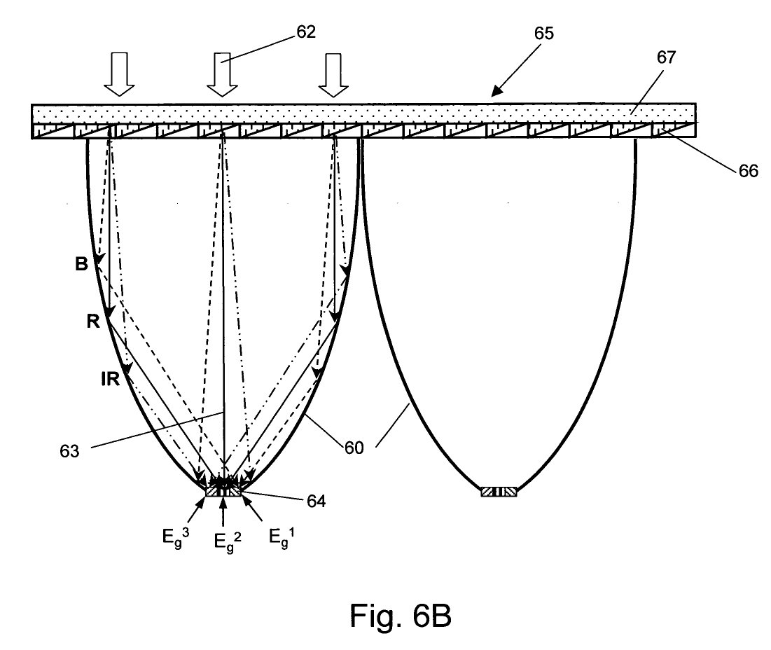

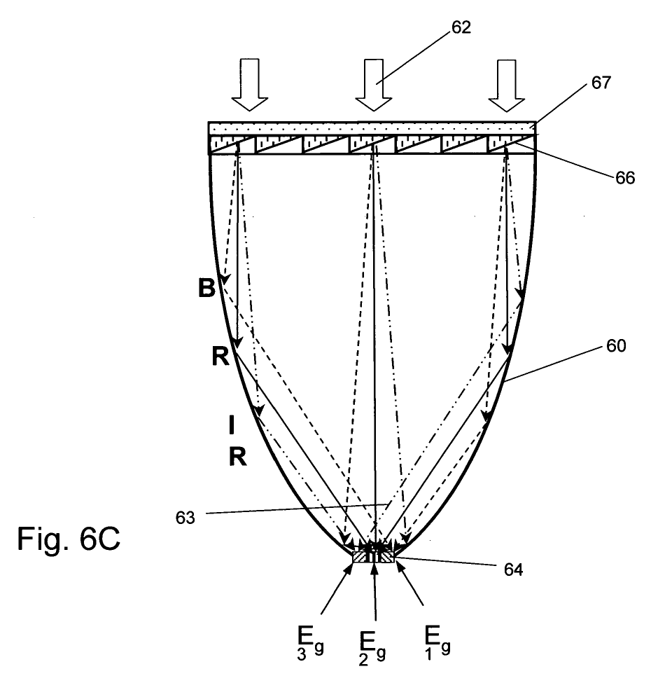

The concentrating optics, which can help focus the spatially decomposed solar spectrum onto the planar multi-band solar cells, can be provided in any number of useful configurations. Preferred designs utilize a compound parabolic concentrator (CPC) 60 of ˜10-50 concentration ratio to concentrate diffracted light, as shown in FIG. 6A. Two typical optical arrangements are presented for using a simple low-profile prism array, 61 to decompose sunlight 62 into a spatially distributed spectrum 63 and functionally direct the resolved light on to appropriate members of a PV cell array 64; each with different band-gap energies appropriate to different parts of the dispersed sunlight. The angular distribution of dispersed sunlight is represented by three major useful rays of blue, red, and infrared. Although CPCs are not imaging devices, they manage to effectively concentrate the rays of dispersed sunlight in different wavelengths at different angles onto different sections of the receiving area. There, three PV cells with different band-gap energies are typically positioned in descending order from the highest to the lowest band gap to match the energy of light in the spectral distribution from blue to infrared. In this embodiment, the CPC body can be tilted either together with the dispersive optics or separately from the optics to optimize the focus of input light to the PV devices. Mechanical tracking of light sources (e.g., the sun) can be important in this embodiment because of the deviation angles resulting inherently from the simple low-profile prisms.

In FIG. 6B, a Zenger-prism based prism array is attached to the front panel 65 of a solar concentrator system containing a plurality of CPCs. The system is much less sensitive to the alignment of the light source; in typical embodiments it can be assumed to be able to track the sun's movement. For example, taking advantage of the dispersive property of Zenger prism 66, the incidence of sunlight can be normal to the panel surface without requiring the CPCs to be tilted.

In FIG. 6C, a Zenger prism array 66 with a transparent substrate 67 can be directly mounted on a CPC 60 for individual sun tracking. The optics can be, e.g., simply a conventional convex lens, or a Fresnel lens, or gradient refractive index (GRIN) lens, as illustrated in FIG. 4. The concentrator can include a frame or other fixture to maintain the prism array, the concentrator optics, and the receivers together in a desired configuration.

Further, with reference to FIG. 4, the concentrator can comprise a transmission diffractive grating and a transparent substrate to which the grating can be attached, a plurality of semiconductor PV receivers with different band-gap energies, and an optical component that illuminates the receiver or receivers with concentrated sunlight that has passed through the grating. The optical component can be a cylindrical lens (e.g., a cylinder section), or a CPC in trough shape for one-dimension linear concentration, or a circular or square-shaped lens (or lateral series of lenses), or a CPC of parabola shape for two-dimension concentration. The concentrating optics can collect all dispersed rays of sunlight behind the grating and concentrate the collected light into a much reduced size (e.g., focused on appropriate PV cells for each light frequency) while preserving the spatial distribution of all the wavelengths. The concentrator assembly can include a fixture to maintain the grating, the concentrator optics, and the receivers together in a desired configuration.

The optical component used in the solar concentrators typically provides a 10˜50-fold concentration of the sun irradiance. The concentrator component can take different forms such as, but not limited to, rectangular or circular shapes, and can be made of any suitable materials. Concentrators can include, e.g., a convex lens, a GRIN lens with gradient increasing refractive index from center plane, a Fresnel lens, a hybrid lens with a cylindrical lens in the center and a set of total internal refection (TIR) structure on the edges and/or the like. The choice of lenses can be influenced by design requirements such as aspect ratio, weight, cost and the reliability desired in the concentrator structure. Other choices of concentrators can include a) compound parabolic mirrors; b) compound hyperbolic mirrors; c) compound elliptic mirrors; d) dielectric total internal reflection concentrators, and the like. These contractors can have a second concentration stage to further improve the quality or magnitude of concentration.

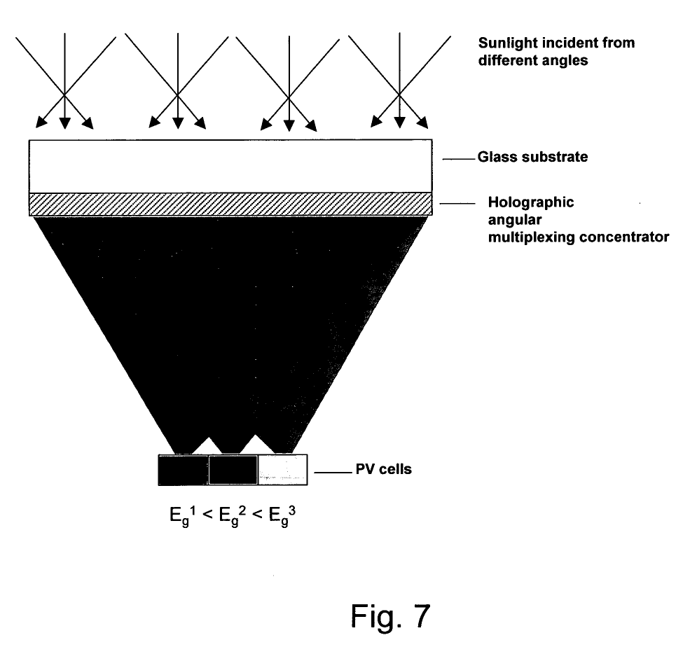

In a further embodiment, the concentrating optics can also provide the dispersive optics function. For example, an angular multiplexed volume holographic grating, as shown in FIG. 7, can provide desired large acceptance angle for a solar concentrator, light dispersion and concentration onto a lateral array of PV cells. The physics of volume diffraction endows the volume holographic gratings with selectivity properties that can be exploited in a multiplexed fashion. Volume holograms can be angularly multiplexed within a single physical volume (S. Tang and R. T. Chen, IEEE Photonics Technol. Lett. 6, 299(1994)) to allow lights from various angles be coupled into the concentrator. It is also possible to construct a surface-normal holographic lens array in conjunction with the angular multiplexed volume grating using holographic recording techniques (S. Tang, T. Li, F. M. Li, C. Zhou, and R. T. Chen, IEEE Photonics Technol. Lett. 8, 1498(1996)) to provide better optical coupling and solar concentration for multi-band solar receivers.

Multiplexed Bragg Grating Devices

Dispersive optical devices can be designed to have a plurality of holograms angularly multiplexed and Bragg matched in a single physical volume. The devices can be integrated into a solar concentrator system to provide a large acceptance angle for the concentrator, consequently reducing the tracking requirements. A spectral dispersive device based on a volume Bragg transmission grating can be provided for integration with a solar concentrator to reducing tracking requirements and improve solar energy conversion efficiency. The device can be designed to have a plurality of holograms angularly multiplexed within a common volume that allow a concentrator to collect sunlight incident from a much wide angle efficiently without tracking. In addition, the spectral distribution from the concentrators can direct light frequencies to appropriate members of laterally deployed PV cells of different band gap energies.

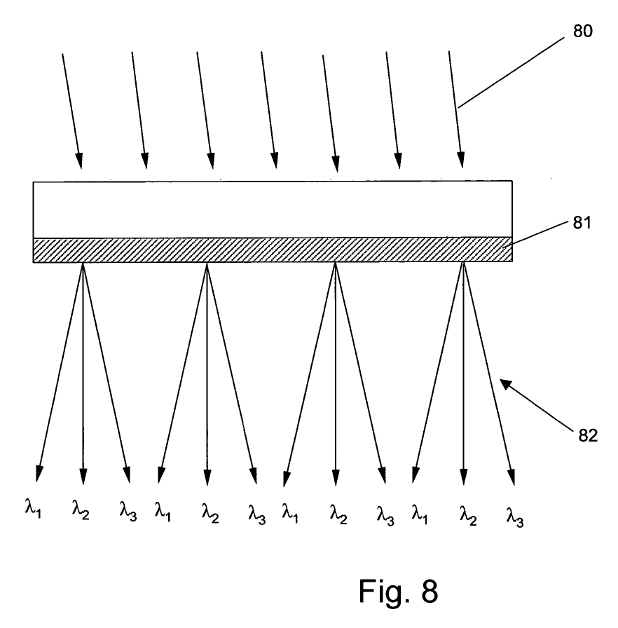

The multiplexed devices of the invention can be made by recording holograms in various phase sensitive media to volume Bragg gratings. Such diffractive devices can be capable of providing spatial distribution of solar spectrum in wavelength, as illustrated in FIG. 8. A beam of white light 80 incident to the grating 81 can be separated into its component colors 82 upon diffraction. With each color diffracted along a different direction, spatial distribution of wavelengths can be provided for the light.

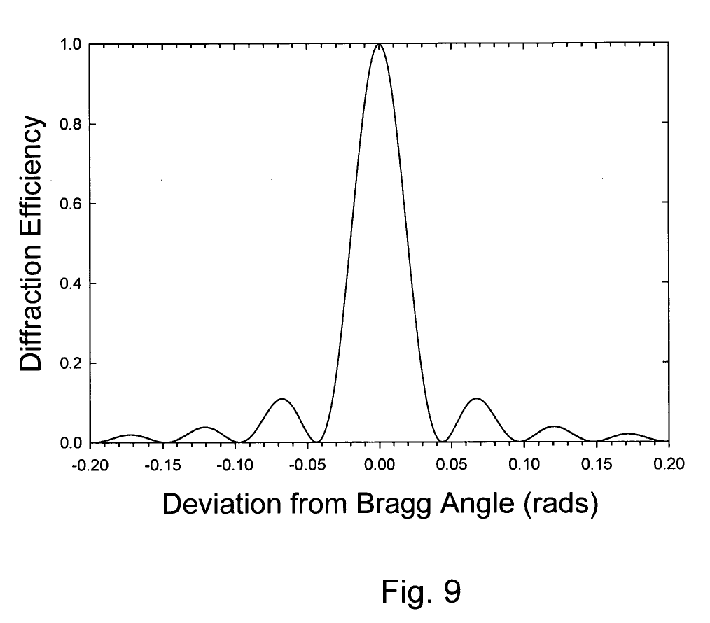

FIG. 9, shows an example of diffraction efficiency of a volume grating recorded in a 100-μm thick photosensitive medium with initial refractive index of n=1.5 and optically induced refractive-index change of Δn=0.0019, defined as the ratio of the first-order diffracted power to the incident power. The finite size (in our case thickness) of the medium has the net effect of spreading the grating angular (k-space) spectrum into a range of angles centered at the incident angle as a broad main lobe. Consequently the Bragg condition can now be (at least partially) satisfied by a range of angles that may not be perfectly Bragg-matched to the grating. The appearance of the so-called Bragg nulls, a discrete set of roughly equally spaced reconstruction angles at which there is essentially no grating diffraction, suggests the possibility of recording many holograms within the same physical volume by using recording waves at angles (or “addresses”) around a nominal center angle, a scheme known as angular multiplexing. Since each hologram can be configured to sit at a Bragg null with respect to all the other holograms, it should thus be possible to reconstruct individual holograms without any interference from the others.

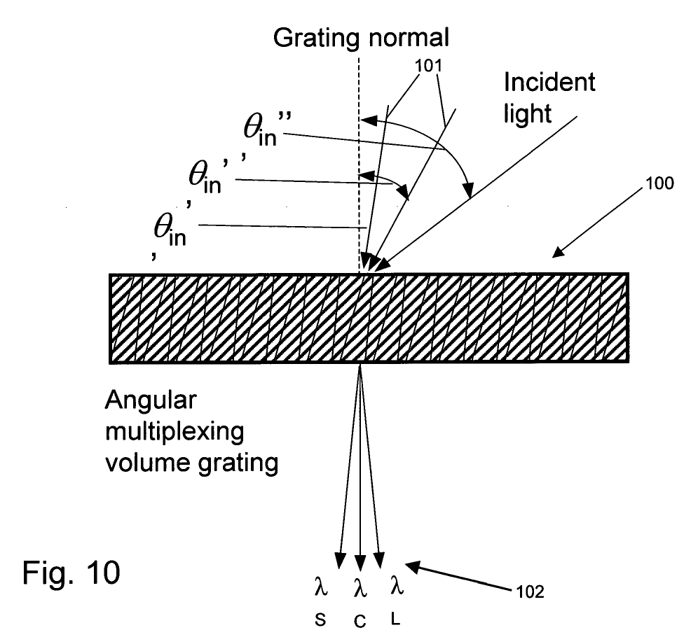

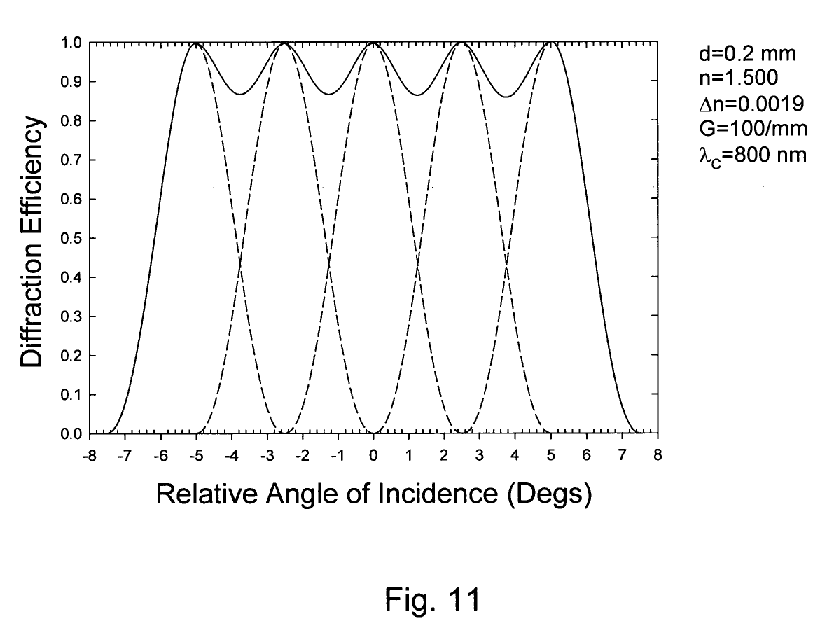

Several holograms that satisfy Bragg condition can be angularly multiplexed within the same physical volume of a multiplexed Bragg grating 100, see FIG. 10. Source light 101 incident from various angles can be diffracted to a common direction (or at lease in a substantially more parallel direction). Moreover, the diffracted incident light can be dispersed to spectral components 102 of similar wavelength with the similar wavelengths directed to substantially the same locations. FIG. 11 shows the overall diffraction efficiency of five separated light sources through a multiplexed device with five angularly-multiplexed holograms. Using the grating parameters listed in the figure, the diffractive device yields a >10° acceptance angle, while retaining very high diffraction efficiency (with the lowest efficiency still larger than 85%).

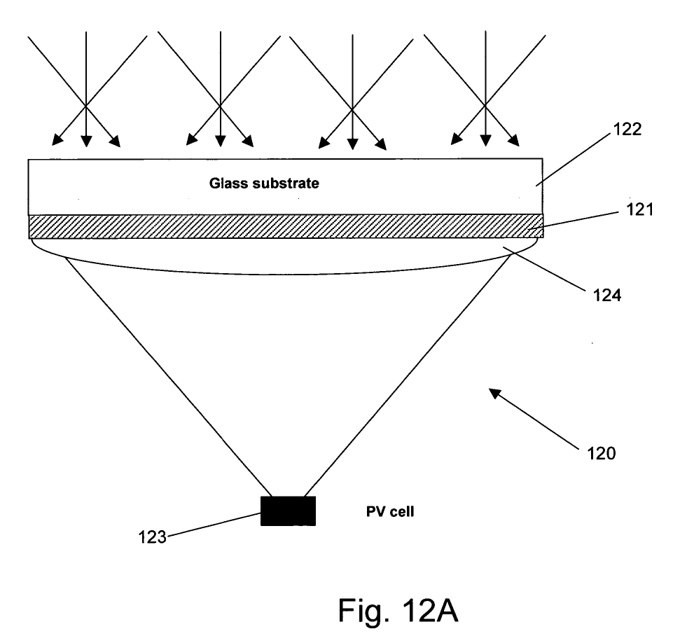

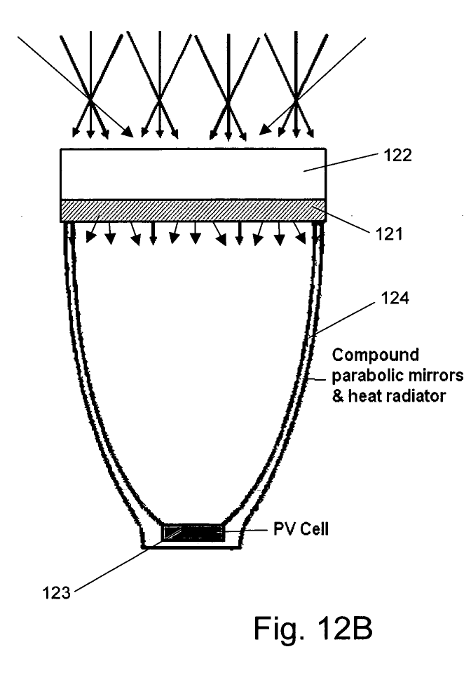

In certain embodiments, angularly-multiplexed diffractive devices are integrated with solar concentrators to provide desired large acceptance angle for colleting beam rays of sunlight along with high degrees of concentration, e.g., onto one or more PV cells. For example, FIG. 12A shows an integrated concentrator 120 comprising an angularly-multiplexed diffractive device 121, a transparent substrate 122 to which the device is attached, a PV receiver cell 123, and an optical concentrator 124 component that can illuminate the receiver with concentrated sunlight, e.g., that has been aligned by passage through the diffractive device. The optical component can optionally be, e.g., a cylindrical lens, a compound parabolic concentrator (CPC) in trough shape for one-dimension linear concentration, a circular or square-shaped lens, or a CPC of parabola shape for two-dimension concentration. The concentrating optics can collect all aligned and dispersed rays of sunlight transmitted through the multiplexing device for concentration onto a much reduced area. The concentrator assembly can include a fixture to maintain the diffractive device, the concentrator optics, and the receiver together in a desired configuration. With the acceptance angle of a concentrator being expanded by the multiplexed grating, solar tracking system for the concentrator assembly can be greatly simplified or eliminated.

The transparent substrate used in the integrated concentrator can benefit the diffractive devices with improved mechanical rigidity and chemical stability. The material of a transparent substrate in preferably glass of high transmittance to the sunlight in the operational wavelength range of the solar cells in the concentrator.

The optical concentrator component used in the multiplexed grating systems of the invention can be as discussed above. For example, the integrated concentrator can provide a 10˜50-fold concentration of the sun irradiance onto the PV cells of the device. The concentrator can be, e.g., a convex lens, a GRIN lens with gradient increasing refractive index from center plane, a Fresnel lens, or a hybrid lens with a cylindrical lens in the center and a set of total internal refection (TIR) structure. Preferred concentrators for use with the multiplexed gratings include, e.g., compound parabolic mirrors (as shown in FIG. 12B), compound hyperbolic mirrors, compound elliptic mirrors, and dielectric total internal reflection concentrators.

The PV receiver used on the concentrators can be as described above generally. For example, the PV cells can include semiconductor single pn-junction solar cells made with Si, Ge, Si₁₋ₓGex, GaAs, GaₓIn₁₋ₓAs, GaₓAl₁₋ₓAs, GaₓIn₁₋ₓP, CuInₓGa₁₋ₓSe₂, where 0≦x≦1, in the crystalline formations including single (mono) crystal, polycrystal, and amorphous state, or monolithic multi-junction solar cells. Cells of these proportional formulas can include, e.g., GaInP/GaAs and GaInP/GaAs/Ge solar cells.

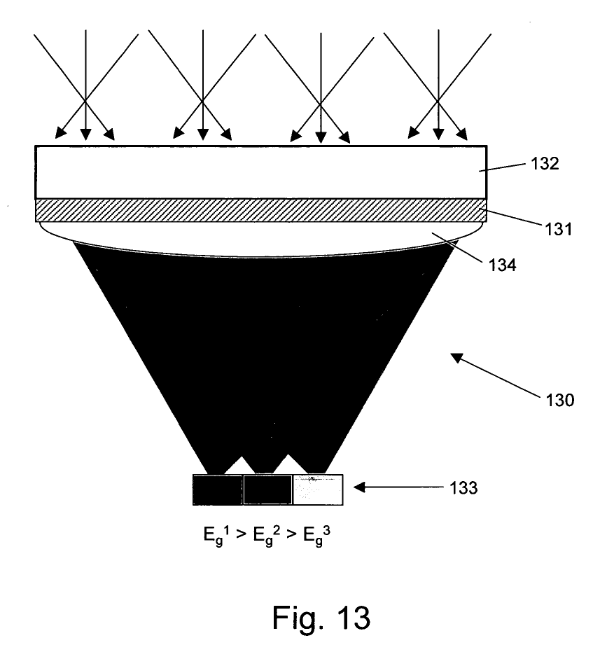

In a further embodiment, the dispersive nature of an angular multiplexed VBG diffractive device, in addition to providing desired large acceptance angle for a solar concentrator, can be utilized to provide direction of common wavelengths of incident light from different sources onto common PV cells. FIG. 13 shows a solar concentrator assembly 130 comprising an angular multiplexed volume Bragg grating diffractive device 131 and a transparent substrate 132 to which the device is attached, a plurality of semiconductor PV receivers 133 with different band-gap energies, and an optical concentration component 134 that illuminates the receivers with concentrated sunlight, e.g., after it has been aligned and diffracted through the grating.

As with other devices discussed above, the optical concentration component can be any suitable for the overall design of the solar conversion device. For example, the concentrator optics can comprise a cylindrical lens, a CPC in trough shape for one-dimension linear concentration, a circular or square-shaped lens, and/or a CPC of parabola shape for two-dimension concentration.

As with the devices discussed above, efficiency of the multiplexed grating embodiments can be enhanced by providing PV cells with different band-gaps. The PV cells can be stacked at the same location or, e.g., provided in a lateral array of PV cells with stepped band-gaps.

Because the multiplexed gratings can provide common diffractive dispersion of light from incoming form various directions, the gratings are well adapted to compliment lateral PV cell arrays. For example, as shown in FIG. 13, a plurality of semiconductor PV cells with different band-gap energies can be placed under the illumination of aligned and dispersed light from a multiplexed grating. Three cells Eg¹, Eg² and Eg³, with stepped band-gap energies of Eg¹>Eg²>Eg³, can be provided in a lateral array to receive the dispersed light. The PV cells can be positioned so that photons in the violet-blue-green spectral region efficiently irradiate cell Eg¹, photons in the yellow-red wavelength range illuminate cell Eg², and photons in the infrared part illuminate cell Eg³.

Electrical Connections with Reduced Resistance

Reduced electrical resistance in solar conversion system wiring can help increase the efficiency of the systems. In an aspect of the invention, methods and configurations are provided to minimize electrical resistances associated with solar cells. A number of schemes are designed to take advantage of the geometrical and mechanical configurations of solar concentrators to make better electrical contacts and connections so as to achieve maximum solar energy conversion efficiency and better power extraction from the available solar irradiance.

Disclosed herein are schemes, e.g., designed to utilize the geometrical configuration and mechanical structural elements of compound parabolic concentrators (CPC) to minimize energy losses resulted from ohmic resistances related to solar cells used in the concentrators so as to achieve maximum solar conversion efficiency for electricity power extraction.

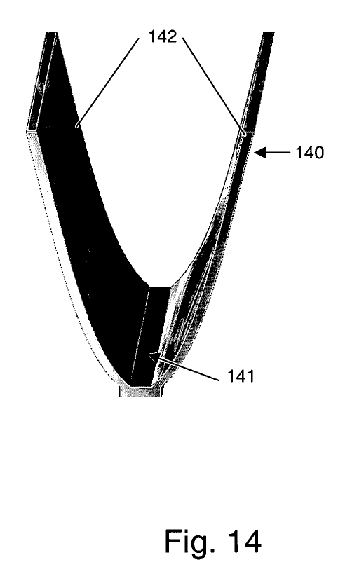

Many reduced electrical resistance embodiments of the invention are applicable to systems suing compound reflective concentrators. A typical solar compound parabolic concentrator (CPC) assembly 140 can comprise a stripe of PV receivers 141, or thermoelectric receivers, or a combination of both, and a pair of compound parabolic reflectors 142 set in trough shape to illuminate the receivers with concentrated sunlight, as schematically illustrated in FIG. 14. The focal points of two parabolic mirror segments and their parabolic surfaces can be symmetrical with respect to reflection through the axis of a CPC. These concentrators have the advantage of large acceptance angles compared to refractive-optics based concentrators. These reflective concentrators also reduce tilted incidence off-focus problems compared to refractive optics.

As with other solar conversion systems of the invention, the PV receivers used in the CPC assemblies can include semiconductor single pn-junction solar cells made from Si, or Ge, Si₁₋ₓGeₓ, GaAs, GaₓIn₁₋ₓAs, GaₓAl₁₋ₓAs, GaₓIn₁₋ₓP, CuInₓGa₁₋ₓSe₂, where 0≦x≦1, in the crystalline formations including single (mono) crystal, polycrystal, and amorphous state. The cells can include monolithic multi-junction solar cells including GaInP/GaAs and GaInP/GaAs/Ge solar cells.

The preferred arrangements of electrical contacts are, e.g., to have all contact electrodes located on back surface. This configuration makes it easier for concentrator assembly and avoids blocking of concentrated sunlight by electrical contacts at the front surface of the cells.

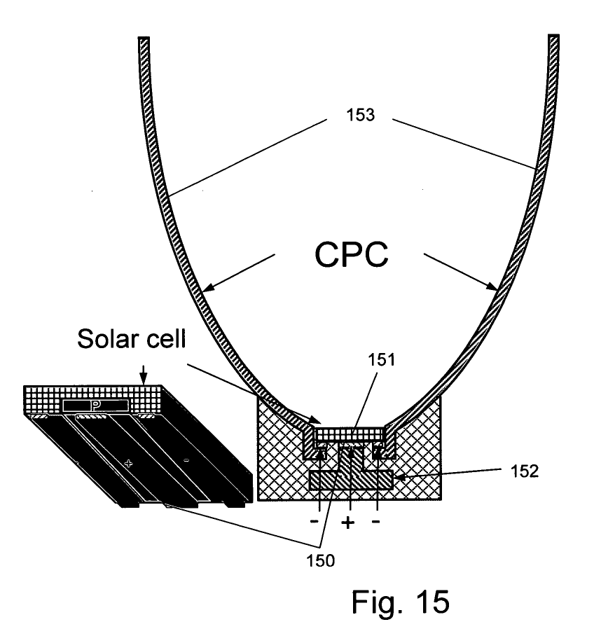

In the embodiments described below, the metallic nature of the parabolic mirror segments is utilized to provide large-area electrical contacts. The mirror segments can serve as current buses for the PV receivers with different back contact configurations embedded in a CPC. For example, in one embodiment, overall ohmic resistances of a solar conversion device are minimized by having one electrical contact in the middle back of the solar cell and the other electrical contact at one or both of metal CPC reflective concentrator structures. The CPC can be metallic parabolic mirror segments fixed to an insulating base. The insulating base can also house a metallic bus of excellent electrical conduction in contact with an electrode of associated PV cells. This configuration allows one or more PV cells to be conveniently mounted into the overall CPC assembly. Referring to FIG. 15, the positive electrodes 150 of the PV receiver stripes 151 can be directly soldered onto the metal bus 152 and the internal edges of two mirror segments 153 can serve as the negative electrode current buses. In this way, the large contact areas are afforded to both polarities of a solar cell. Further, the configuration eliminates substantial lengths of interconnection wiring, thus reducing the overall electrical resistance of the concentrator assembly to a minimum.

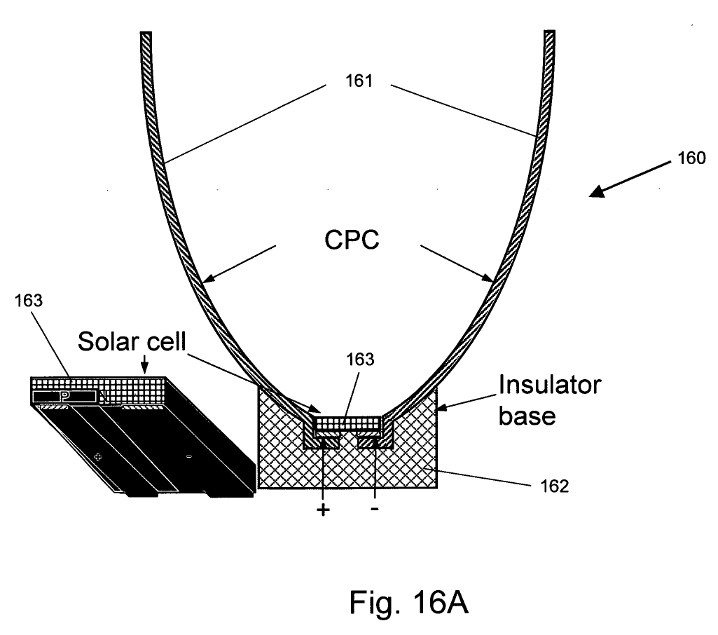

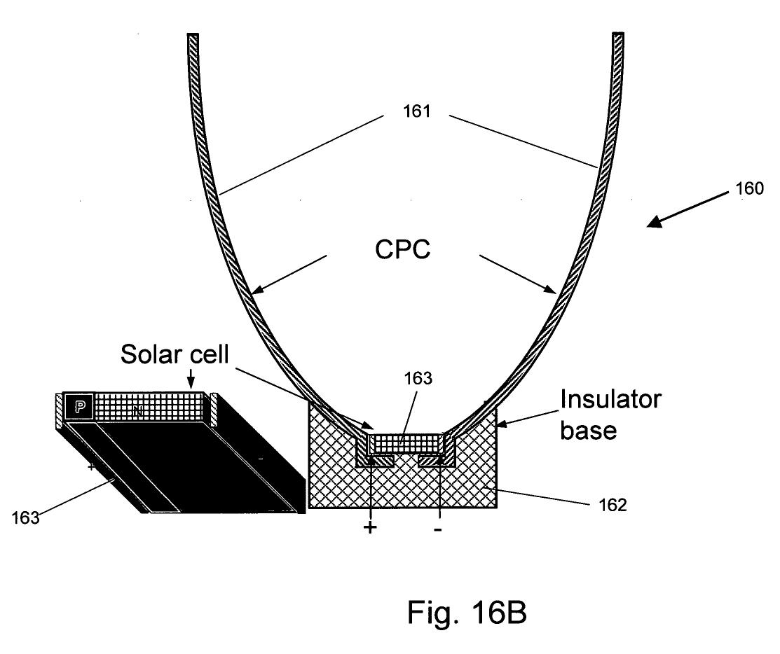

In another embodiment to maximize the electrical conduction, the solar cell has back contacts located side by side. In this embodiment the pair of metal parabolic reflectors act as a pair of long contacts and conductors for the electric current of the cells. The CPC assembly 160 can have the metallic parabolic mirrors 161 simply fixed to an insulating base 162 made to accommodate one or more solar cells 163 at the bottom of the CPC assembly. With the solar cell straddling the insulating gap between the two parabolic mirrors, the contact electrodes can be directly soldered on the lower edges of the two mirror segments, as illustrated in FIG. 16A. In this embodiment, the each of the CPC mirrors can serve as a lead for the PV receiver electrodes. This embodiment can also be applicable to so-called sliver cell configuration where the contact electrodes of a solar cell are located at its lateral sides. Referring to FIG. 16B, the n- and p-contacts of such a sliver cell may easily be mounted into a CPC in the same way to attain large contact areas for both polarities of the cell without any connection wiring.

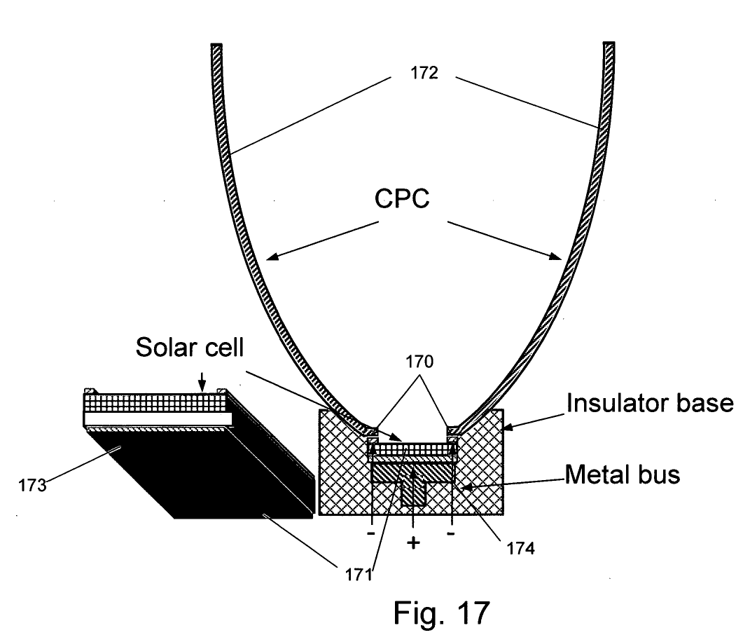

FIG. 17 shows a way to attach low resistance conductors to solar cells, which have both front and back contact electrodes. For a cell with top contact symmetrically located on two sides of the top surface and with a full back surface contact, it can be mounted into a CPC in a way similar to that depicted in FIG. 15, except the metallic parabolic mirror segments are sitting on top of the cell. In this way, referring to FIG. 17, the top electrodes 170 of the cell 171 can be directly soldered to the ends of two mirror segments 172, and the bottom electrode 173 can contact the metal bus 174.

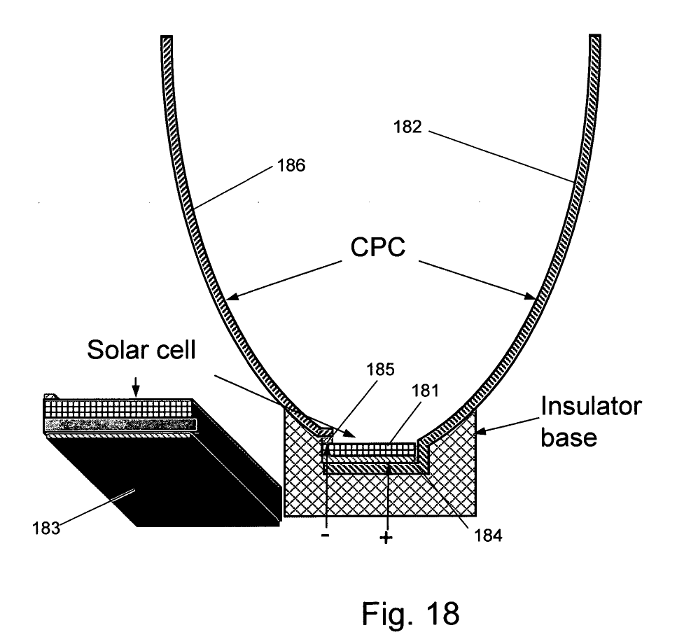

For a PV receiver with its top contact on only one side of the top surface, a moderate modification to one metallic parabolic mirror segment needs to be made in order to provide maximum contact area for the electrodes of the cell. Referring FIG. 18, the solar cell 181 may sit on the extended end flange of one parabolic mirror 182 with its entire area of the bottom electrode 183 making contact to the flange 184, while the top electrode 185 is soldered to the lower edge of the other mirror segment 186 to secure excellent ohmic contacts between the electrodes of the solar cell and the parabolic mirror segments.

A novel feature of the present embodiments is that the large surface area of the mirror segments in a CPC can also be used to dissipate heat from its solar receiver generated by concentrated illumination of the sunlight. Heat is quickly removed from the solar cells to the mirror sheets to which the solar cells are attached through the large-area heat and electric conductive contacts.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the techniques and apparatus described above can be used in various combinations.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A device for conversion of light energy into electrical energy, which device comprises:
a lateral array of two or more different photovoltaic cells, wherein the different cells have different band gap energies.

2. The device of claim 1, wherein the cells comprise a first cell with a band gap energy of about 1 eV and a second cell with a band gap energy ranging from about 1.3 eV to about 2 eV.

3. The device of claim 1, wherein the device comprises three or more different photovoltaic cells.

4. The device of claim 3, wherein the cells comprise a first cell with a band gap energy of about 1 eV and a second cell with a band gap of about 1.3 eV and a third cell with a band gap of about 2 eV.

5. The device of claim 1, wherein the device does not comprise a three-dimensional array of photovoltaic cells or a stack of photovoltaic cells.

6. The device of claim 1, further comprising dispersive optics positioned in a light path between a light source and the lateral array of photovoltaic cells;
wherein light from the light source is dispersed spectrally by wavelength to appropriately illuminate the cells according to band gap energies.

7. The device of claim 6, wherein the dispersive optics are selected from the group consisting of: a low-profile prism array, a prism array without zone spacing, a Zenger prism, a Zenger prism array, a grism, a holographic volume Bragg grating and a multiplexed volume Bragg grating.

8. The device of claim 6, wherein the dispersive optics: a) function by refraction; b) do not function by reflection; c) do not function by light absorbance; or d) transmit substantially all visible light incident from a normal angle.

9. The device of claim 6, further comprising a reflective or refractive light concentrator positioned in the light path between the light source and the dispersive optics.

10. A device for conversion of light energy into electrical energy, which device comprises:
one or more photovoltaic cells;
a light path from the exterior of the device to the one or more cells;
dispersion optics in the light path between the exterior of the device and the one or more cells; and
a light concentrator in the light path between the dispersion optics and the one or more cells.

11. The device of claim 10, wherein the photovoltaic cells comprise two or more cells in a lateral array of cells.

12. The device of claim 11, wherein adjacent cells in the array have different band gap energies.

13. The device of claim 10, wherein the dispersive optics are selected from the group consisting of: a low-profile prism array, a prism array without zone spacing, a Zenger prism, a Zenger prism array, a grism, a holographic volume Bragg grating and a multiplexed volume Bragg grating.

14. The device of claim 10, wherein the light concentrator is selected from the group consisting of: a lens, a cylindrical lens, a compound parabolic reflector, a compound hyperbolic reflector, a compound elliptic reflector, and a total internal reflection concentrator.

15. A device for conversion of light energy into electrical energy, which device comprises:
a lateral array of three or more photovoltaic cells, wherein each of the three or more cells has a different band gap energy.

16. The device of claim 15, wherein the cells comprise a first cell with a band gap energy of about 1 eV and a second cell with a band gap of about 1.3 eV and a third cell with a band gap of about 2 eV.

17. The device of claim 15, further comprising the dispersive optics positioned in a light path to appropriately disperse light and illuminate the cells according to band gap.

18. The device of claim 17, wherein the dispersive optics are selected from the group consisting of: a low-profile prism array, a prism array without zone spacing, a Zenger prism, a Zenger prism array, a grism, a holographic volume Bragg grating and a multiplexed volume Bragg grating.

19. The device of claim 15, further comprising a light concentrator positioned in a light path configured to concentrate light upon the three or more cells.

20. The device of claim 19, wherein the light concentrator is selected from the group consisting of: a lens, a cylindrical lens, a compound parabolic reflector, a compound hyperbolic reflector, a compound elliptic reflector, and a total internal reflection concentrator.

21. A device for conversion of light energy into electrical energy, which device comprises:
a photovoltaic cell comprising a voltage potential between a first contact electrode and a second contact electrode when a surface of the cell is exposed to light;
a first metal reflector configured to reflect light onto the surface and in direct electrical contact with the first electrode or the second electrode;
wherein the reflector comprises a conductor in a circuit when current is generated by the photovoltaic cell.

22. The device of claim 21, wherein the first reflector is in heat conductive contact with the photovoltaic cell, thereby conducting heat from the photovoltaic cell.

23. The device of claim 21, wherein the first electrode or second electrode is not in direct electrical contact with a wire.

24. The device of claim 21, wherein the surface exposed to light is a front surface and wherein the cell further comprises a back surface comprising the first electrode.

25. The device of claim 24, further comprising a metal buss in direct electrical contact with the back surface first electrode; and,
wherein in the reflector is in direct electrical contact with the second electrode.

26. The device of claim 24, further comprising a second metal reflector configured to reflect light onto the surface and in direct electrical contact with the back surface first electrode; and,
wherein in the first reflector is in direct electrical contact with the second electrode.

27. The device of claim 21, wherein the reflector is selected from the group consisting of: a compound parabolic reflector, a compound hyperbolic reflector, a compound elliptic reflector, and a total internal reflection concentrator.

28. The device of claim 21, further comprising two or more of the photovoltaic cells, each with different band gap energies; and,
dispersive optics positioned in a path of the light to disperse the light and functionally illuminate the cells according to band gap energy.

29. The device of claim 28, wherein the dispersive optics are selected from the group consisting of: a low-profile prism array, a prism array without zone spacing, a Zenger prism, a Zenger prism array, a grism, a holographic volume Bragg grating and a multiplexed volume Bragg grating.

30. A device for conversion of light energy into electrical energy, which device comprises:
one or more photovoltaic cells; and,
an angularly multiplexed volume Bragg grating in a light path functioning to direct light onto the one or more photovoltaic cells.

31. The device of claim 30, wherein the photovoltaic cells comprise a lateral array of cells comprising two or more different band gap energies.

32. The device of claim 31, wherein the grating is positioned to disperse incident light into spectral components according to wavelength and to direct the spectral components onto cells of the array that have the closest band gap energy match at or above the energy of the spectral component.

33. The device of claim 30, wherein the multiplexed grating comprises a primary grating with a primary incidence angle and comprising one or more secondary gratings recorded in one or more Bragg nulls of the primary grating and with peripheral secondary incidence angles different from the primary angle.

34. The device of claim 33, wherein the grating comprises from 2 to 8 secondary incidence angles of secondary gratings recorded in the Bragg nulls.

35. The device of claim 30, further comprising a light concentrator positioned in the light path configured to concentrate light upon the one or more cells.

36. The device of claim 35, wherein the light concentrator is selected from the group consisting of: a lens, a cylindrical lens, a compound parabolic reflector, a compound hyperbolic reflector, a compound elliptic reflector, and a total internal reflection concentrator.
